(19) United States
(12) Patent Application Publication
(10) Pub. No.: US 2001/0024700 A1
(43) Pub. Date: Sep. 27, 2001

(54) Ruthenium-containing ultrasonically coated substrate for use in a capacitor and method of manufacture

(76) Inventors: Asbish Shah, East Amherst, NY (US); Barry C. Muffoletto, Alden, NY (US)

Correspondence Address: Michael F. Scalise, Hodgson Russ LLP, Suite 2000, One M&T Plaza, Buffalo, NY, 14203-2391, US

(21) Appl. No.: 09/872,110

(22) Filed: Jun. 1, 2001

Related U.S. Application Data
(63) Continuation-in-part of application No. 09/280,445, filed on Mar. 29, 1999.
Application No. 09/280,445 is a continuation-in-part of application No. 08/858,150, filed on May 1, 1997, now Pat. No. 5,894,403.

(51) Int. Cl. B05D 3/02; B06B 1/00

(52) U.S. Cl. 427/600; 427/314; 427/376.2

(57) ABSTRACT

A deposition process for coating a substrate with an ultrasonically generated aerosol spray, is described. The resultant droplets are much smaller in size than those produced by conventional processes, thereby providing the present coating having an increased surface area. When the coated substrate is an electrode in a capacitor, a greater surface area results in an increased electrode capacitance. A preferred coating is of a ruthenium-containing oxide.

### CROSS-REFERENCE TO RELATED APPLICATION

This application is a continuation-in-part application of U.S. application Ser. No. 09/280,445, filed Mar. 29, 1999, which is a continuation-in-part application of U.S. application Ser. No. 08/858,150, now U.S. Pat. No. 5,894,403 to Shah et al.

### BACKGROUND OF THE INVENTION

1. Field of the Invention

The present invention generally relates to a deposition process for coating a substrate with an ultrasonically generated aerosol spray. More particularly, the present invention relates to a metallic foil provided with an ultrasonically generated aerosol spray. Still more particularly, the present invention provides a porous, high surface area coating of a ruthenium-containing compound on a conductive foil for use in a capacitor and the like.

2. Prior Art

In redox active structures, energy storage occurs during a change in the oxidation state of the metal when an ionic species from a conducting electrolyte, for example a proton, reacts with the surface or bulk of the oxide. This chemisorption is accompanied by the simultaneous incorporation of an electron into the oxide. The surface (or bulk) interaction between the electrode and electrolyte gives rise to capacitance in the hundreds of μF/sq.cm. It follows that an electrode with high specific surface area is capable of storing a significant amount of energy and having a large specific capacitance. These electrodes are then appropriate when used as the anode and/or cathode in electrochemical capacitors or as cathodes in electrolytic capacitors, which require high specific capacitances.

Whether an anode or a cathode in an electrochemical capacitor or the cathode in an electrolytic capacitor, a capacitor electrode generally includes a substrate of a conductive metal such as titanium or tantalum provided with a semiconductive or pseudocapacitive oxide coating, nitride coating, carbon nitride coating, or carbide coating. In the case of a ruthenium oxide cathode, the coating is formed on the substrate by dissolving a ruthenium-containing compound, or a precursor thereof such as ruthenium chloride or ruthenium nitrosyl nitrate, in a solvent and contacting the solution to the substrate. The thusly coated substrate is then heated to a temperature sufficient to convert the deposited precursor to a highly porous, high surface area pseudocapacitive film of the ruthenium-containing compound provided on the substrate.

The prior art describes various methods of contacting the substrate with the semiconductive or pseudocapacitive solution, or precursor thereof. Commonly used techniques include dipping and pressurized air atomization spraying of the active materal or its precursor onto the substrate. However, capacitance values for electrodes made by dipping, pressurized air atomization spraying and sputtering are lower in specific capacitance. Sol-gel deposition is another conventional method of coating the substrate. Additionally, it is exceptionally difficult to accurately control the coating morphology due to the controllability and repeatability of the various prior art techniques, which directly impacts capacitance.

Therefore, while electrochemical capacitors provide much higher energy storage densities than conventional capacitors, there is a need to further increase the energy storage capacity of such devices. One way of accomplishing this is to provide electrodes which can be manufactured with repeatable controllable morphology according to the present invention, in turn benefitting repeatable increased effective surface areas.

### SUMMARY OF THE INVENTION

The present invention describes the deposition of an ultrasonically generated, ruthenium-containing aerosol spray onto a conductive substrate. When a liquid is ultrasonically atomized, the resultant droplets are much smaller in size than those produced by a pressurized air atomizer and the like, i.e., on the order of microns and submicrons in comparison to predominately tens to hundreds of microns, which results in a greater surface area coating. Therefore, the capacitance of electrochemical capacitors and electrolytic capacitors is further improved by using an electrode coated with an ultrasonically deposited porous film of a pseudocapacitive material, such as a ruthenium-containing compound, to increase the surface area of the electrodes.

These and other aspects of the present invention will become more apparent to those skilled in the art by reference to the following description and the appended drawings.

### BRIEF DESCRIPTION OF THE DRAWINGS

FIG. 1 is an elevational view of an ultrasonic aerosol deposition apparatus 10 according to the present invention.

FIG. 2 is a schematic of a unipolar electrode configuration for use in an electrochemical capacitor.

FIG. 3 is a schematic of a bipolar electrode configuration for use in an electrochemical capacitor.

FIG. 4 is a schematic of a hybrid capacitor according to the present invention.

FIG. 5 is a schematic of a spirally wound configuration for use in a electrochemical capacitor.

FIGS. 6 to 9 are color photographs of various tantalum substrates contacted with an ultrasonically generated aerosol solution of ruthenium chloride dissolved in deionized water and nitric acid, and heated to an annealing temperature of 250° C., 300° C., 350° C. and 400° C., respectively.

FIGS. 10 to 13 are color photographs of the substrates of FIGS. 6 to 9, respectively, after having been subjected to a sonication adhesion test.

FIGS. 14 and 15 are photographs taken through an electron microscope at 500× and 5,000×, respectively, showing the surface condition of a ruthenium oxide coating produced by pressurized air atomization spraying according to the prior art.

FIGS. 16 and 17 are photographs taken through an electron microscope at 500× and 5,000×, respectively, showing the surface condition of a ruthenium oxide coating produced from an ultrasonically generated aerosol/mist according to the present invention.

FIG. 18 is a graph of the capacitance versus frequency for a capacitor made according to the prior art in comparison to one of the present invention.

FIG. 19 is a graph of the resistance versus frequency for a capacitor made according to the prior art in comparison to one of the present invention.

FIG. 20 is a graph of two capacitors, one constructed according to the prior art and one according to the present invention, plotted with respect to an ideal capacitor.

### DESCRIPTION OF THE PREFERRED EMBODIMENTS

The patent or application file contains at least one drawing executed in color. Copies of this patent or patent application publication with color drawings will be provided by the Office upon request and payment of the necessary fee.

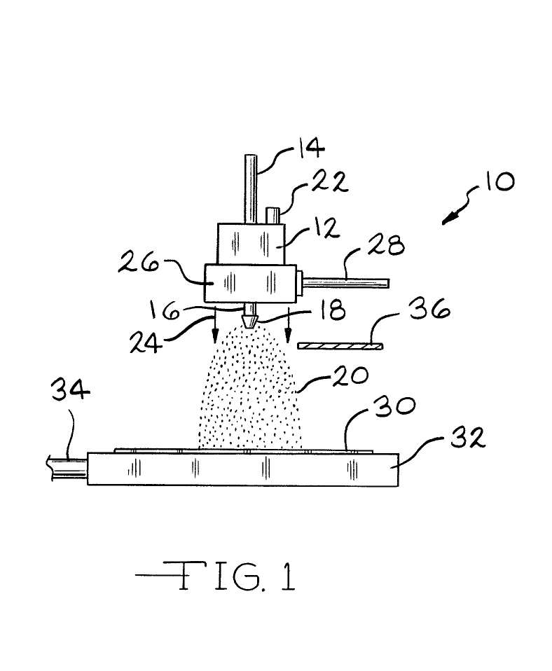

Referring now to the drawings, FIG. 1 illustrates a preferred ultrasonic aerosol deposition apparatus 10 according to the process of the present invention. While not shown in the figure, the first step in the process includes providing a solution of reagents that are intended to be formed into an ultrasonically generated aerosol according to the present invention. The reagent solution is fed into or otherwise provided in a reagent chamber 12 via a feed line 14. The reagent solution preferably contains ions in substantially the ratio needed to form the desired coating from the ultrasonically generated aerosol. These ions are preferably available in solution in water soluble form such as in water soluble salts. However, salts including nitrates, sulfates and phosphates of the cations which are soluble in other solvents such as organic and inorganic solvents may be used. Water soluble salts include nitrates and chlorides. Other anions which form soluble salts with the cations also may be used.

The reagent solution in the chamber 12 is moved through a conduit 16 to an ultrasonic nozzle 18. The reagent solution is caused to spray from the nozzle 18 in the form of an aerosol 20, such as a mist, by any conventional means which causes sufficient mechanical disturbance of the reagent solution. In this description, the term aerosol 20 refers to a suspension of ultramicroscopic solid or liquid particles in air or gas having diameters of from about 0.1 microns to about 100 microns and preferably less than about 20 microns. Examples include smoke, fog and mist. In this description, the term mist refers to gas-suspended liquid particles having diameters less than about 20 microns.

In the preferred embodiment of the present invention, the aerosol/mist 20 is formed by means of mechanical vibration including ultrasonic means such as an ultrasonic generator (not shown) provided inside reagent chamber 12. The ultrasonic means contacts an exterior surface of the conduit 16 and the ultrasonic nozzle 18 assembly. Electrical power is provided to the ultrasonic generator through connector 22. As is known to those skilled in the art, ultrasonic sound waves are those having frequencies above 20,000 hertz. Preferably, the ultrasonic power used to generate the aerosol/mist 20 is in excess of one-half of a watt and, more preferably, in excess of one watt. By way of illustration, an ultrasonic generator useful with the present invention is manufactured by Sonotek of Milton, New York under model no. 8700-120MS.

It should be understood that the oscillators (not shown) of the ultrasonic generator may contact an exterior surface of the reagent chamber 12 such as a diaphragm (not shown) so that the produced ultrasonic waves are transmitted via the diaphragm to effect misting of the reagent solution. In another embodiment of the present invention, the oscillators used to generate the aerosol/mist 20 are in direct contact with the reagent solution. The reagent chamber 12 may be any reaction container used by those skilled in the art and should preferably be constructed from such weak acid-resistant materials as titanium, stainless steel, glass, ceramic and plastic, and the like.

As the aerosol/mist 20 sprays from the ultrasonic nozzle 18, the spray is contained by a shroud gas represented by arrows 24. The shroud gas 24 does not contact the reagent solution prior to atomization, but instead sprays from a plurality of shroud gas nozzles (not shown) supported by an air shroud chamber 26 serving as a manifold for the nozzles disposed in an annular array around the ultrasonic nozzle 18. The shroud gas 24 is introduced into the air shroud chamber 26 via feed line 28 and discharges from the shroud gas nozzles at a flow rate sufficient to screen and direct the aerosol/mist 20 toward a substrate 30 supported on a holder or a support block 32. For example, with the aerosol/mist 20 spraying from the ultrasonic nozzle 18 at a flow rate of from about 0.1 cc to 10 cc per minute, the flow rate of the shroud gas 24 is from about 500 cc to about 25 liters per minute.

Substantially any gas which facilitates screening, directing and shaping the aerosol 20 may be used as the shroud gas 24. For example, the shroud gas may comprise oxygen, air, argon, nitrogen, and the like. It is preferred that the shroud gas 24 be a compressed gas under a pressure in excess of 760 millimeters of mercury. Thus, the compressed shroud gas 24 facilitates the spraying of the aerosol/mist 20 from the ultrasonic nozzle 18 onto the substrate 30.

Substrate 30 preferably consists of a conductive metal such as titanium, molybdenum, tantalum, niobium, cobalt, nickel, stainless steel, tungsten, platinum, palladium, gold, silver, copper, chromium, vanadium, aluminum, zirconium, hafnium, zinc, iron, and mixtures and alloys thereof.

Regardless of the material of substrate 30, ultrasonically deposited spray coatings rely mostly upon mechanical bonding to the substrate surface. It is, therefore, critical that the substrate surface to be coated is properly prepared to ensure coating quality. For one, substrate surface cleanliness is very important in all coating systems, especially in ultrasonically deposited spray coatings. In that respect, it is required that the substrate surface remain uncontaminated by lubricants from handling equipment or body oils from hands and the like. Substrate cleaning includes chemical means such as conventional degreasing treatments using aqueous and non-aqueous solutions, as well known to those skilled in the art. Plasma cleaning is also contemplated by the scope of the present invention.

It is further contemplated by the scope of the present invention that, if desired, the electrical conductivity of the substrate is improved prior to coating. Metal and metal alloys have a native oxide present on their surface. This is a resistive layer and hence, if the material is to be used as a substrate for a capacitor electrode, the oxide is preferably removed or made electrically conductive prior to deposition of a semiconductive or pseudocapacitive coating thereon. In order to improve the electrical conductivity of the substrate, various techniques can be employed. One is shown and described in U.S. Pat. No. 5,098,485 to Evans, the disclosure of which is hereby incorporated by reference.

A preferred method for improving the conductivity of the substrate includes depositing a minor amount of a metal or metals from Groups IA, IVA and VIIIA of the Periodic Table of Elements onto the substrate. Aluminum, manganese, nickel and copper are also suitable for this purpose. The deposited metal is then “intermixed” with the substrate material by, for example, a high energy ion beam or a laser beam directed towards the deposited surface. These substrate treating processes are performed at relatively low temperatures to prevent substrate degradation and deformation. Additionally, these treating processes can be used to passivate the substrate from further chemical reaction while still providing adequate electrical conductivity. For additional disclosure regarding improving the electrical conductivity of the substrate 30 prior to deposition, reference is made to patent application Ser. No. 08/847,946, entitled “Method For Improving Electrical Conductivity of Metal, Metal Alloys and Metal Oxides”, which is assigned to the assignee of the present invention and incorporated herein by reference.

Surface roughness is another critical factor to consider when properly applying an ultrasonically deposited spray coating. The substrate 30 may be roughened by chemical means, for example, by contacting the substrate with hydrofluoric acid and/or hydrochloric acid containing ammonium bromide and methanol and the like, by plasma etching, and by mechanical means such as scraping, machining, wire brushing, rough threading, grit blasting, a combination of rough threading then grit blasting and abrading such as by contacting the substrate with Scotch-Brite™ abrasive sheets manufactured by 3M.

The reagent solution preferably contains ions in substantially the stoichiometric ratio needed to form the desired coating. In one embodiment, the ions are present in the reagent solution in a water-soluble form as water-soluble salts. Suitable water-soluble salts for a ruthenium-containing compound include nitrates and, to a lesser extent, chlorides of the cations. Alternatively, salts such as sulfates and phosphates soluble in organic and inorganic solvents other than water may be used.

The aerosol/mist contacted substrate 30 consists essentially of a porous film coating (not shown) including an oxide of a ruthenium-containing compound, or a precursor thereof, the oxide having pseudocapacitive properties. For example, in the case where it is intended that the resulting pseudocapacitive film is of ruthenium-containing oxide, the deposited mixture can include an oxide of the product compound, or as a precursor, a nitrate, a sulfate, a phosphate and a chloride of the ruthenium-containing compound.

The porous coating may also include a second or more metals. The second metal is in the form of an oxide, or precursors thereof, and is not essential to the intended use of the coated foil as a capacitor electrode and the like. The second metal is selected from one or more of the group consisting of tantalum, titanium, nickel, iridium, platinum, palladium, gold, silver, cobalt, molybdenum, manganese, tungsten, iron, zirconium, hafnium, rhodium, vanadium, osmium, niobium, and mixtures thereof. In a preferred embodiment of the invention, the porous coating includes oxides of ruthenium and tantalum, or precursors thereof.

In general, as long as the metals intended to comprise the coating are present in solution in the desired stoichiometry, it does not matter whether they are present in the form of a salt, an oxide, or in another form. However, preferably the solution contains either the salts of the coating metals, or their oxides.

The reagent solution is preferably at a concentration of from about 0.01 to about 1,000 grams of the reagent compounds per liter of the reagent solution. In one embodiment of the present invention, it is preferred that the reagent solution has a concentration of from about 1 to about 300 grams per liter and, more preferably, from about 5 to about 40 grams per liter.

The support block 32 for substrate 30 is heated via a power cable 34. During the ultrasonic spray deposition of the aerosol/mist 20 onto the substrate 30, support block 32 maintains the substrate 30 at a temperature sufficient to evaporate or otherwise drive off the solvent from the deposited reagent mixture. As will be described in detail hereinafter, the coated substrate is then subjected to a separate heating step to convert the precursor to the oxide and to diffuse the deposited ions into the substrate for proper bonding or adhesive strength. This heating step is in addition to heating the substrate to evaporate the solvent.

Thus, as the substrate 30 is being coated with the ruthenium-containing compound, or precursor thereof, the coated substrate is heated to a temperature sufficient to begin driving off or otherwise evaporating the solvent material. Preferably the solvent is evaporated from the substrate almost instantaneously with contact of the aerosol/mist 20 to the substrate resulting in the deposition of a relatively thin film coating of the ruthenium-containing compound, or a precursor thereof. In the case of an aqueous solution, the substrate is heated to a first temperature of at least about 100° C. to instantaneously evaporate the water from the deposited reagent mixture. More preferably, as the deposition of the aerosol is taking place, the substrate is heated to the first temperature of up to about 220° C. The higher the first temperature, the greater the rate of evaporation of the solvent.

An important aspect of the present invention is that the solvent solution is devoid of alcohol. While alcohol based solvent systems such as those containing isopropanol, ethanol and butanol are commonly used for creating a solution of a semiconductive or pseudocapacitive compound, they limit the temperature to which the substrate can be heated. For example, isopropanol has a flash point of 53° F. A lower first heating temperature, in turn, affects diffusion of the deposited ions into the structure of the substrate. This ultimately impacts the bonding or adhesive strength of the deposited materials to the substrate.

After spraying and in the case where the resulting film is intended to be a ruthenium-containing oxide compound, the deposited nitrate, sulfate, phosphate or chloride precursor is heated to a temperature sufficient to convert the deposited compound to a highly porous, high surface area pseudocapacitive film. Typical heating times for ruthenium oxides range from about one-half hour to about six hours.

For example, after spraying and solvent removal, the precursor coated substrate is heated to a second temperature of about 100° C. to 300° C., preferably about 250° C., for about one hour, followed by a further heating to a third temperature of about 250° C. to 400° C., preferably about 300° C., for about two hours. This is immediately followed by a further heating to a fourth temperature of about 300° C. to about 500° C., preferably at least about 350° C., for at least about two hours.

While this three step heating process is one embodiment of a heating protocol for converting a precursor to a ruthenium-containing oxide, it is contemplated by the scope of the present invention that ruthenium-containing oxides may be formed by a two step or a four step or more heating protocol, as long as the last heating is at least about 300° C., and more preferably at least about 350° C., for at least about one-half hour. The significance of the final heating being at least 300° C., and more preferably at least about 350° C., will be described in detail hereinafter in Examples II and III. In the case of a two step heating protocol, one of the above described second and third heating steps is eliminated. In the case of a four step or more heating process, an additional one or more heating steps is added between the first deposition heating and the fourth heating at the temperature range of about 300° C. to about 500° C.

Alternatively, after the initial deposition heating, the temperature is slowly and steadily ramped up, for example, at about 1° C./minute, preferably about 6° C./min. until the temperature reaches at least about 300° C., and more preferably at least about 350° C., where it is maintained for a time sufficient to allow conversion of the precursor to its final form as a ruthenium-containing oxide and to sufficiently diffuse the active material into the substrate. Heating at 300° C., and more preferably at 350° C., is for about one-half hour or longer. Upon completion of the heating protocol, the heated and coated substrate is allowed to slowly cool to ambient temperature. In general, it is preferred to conduct this heating while contacting the substrate with air or an oxygen-containing gas.

It is preferred that the resulting porous ruthenium-containing oxide coating have a thickness of from about a hundred Angstroms to about 0.1 millimeters, or more. The porous coating has an internal surface area of about 10 m²/gram to about 1,500 m²/gram. In general, the thickness of substrate 30 is typically in the range of about 0.001 millimeters to about 2 millimeter, and preferably about 0.1 millimeters. Also, a majority of the particles of the porous coating have diameters of less than about 10 microns.

During heating, temperature sensing means (not shown) are used to sense the temperature of the substrate 30 and to adjust the power supplied to the support block 32 to regulate the substrate temperature, as previously described.

One advantage of the present process is that the substrate 30 may be of substantially any size or shape, and it may be stationary or movable. Because of the speed of the coating process, the substrate 30 may be moved across the spray emitting from nozzle 18 to have any or all of its surface coated with the film. The substrate 30 is preferably moved in a plane which is substantially normal to the direction of flow of the aerosol region 20. In another embodiment, the substrate 30 is moved stepwise along a predetermined path to coat the substrate only at certain predetermined areas. In another embodiment of the present process, rotary substrate motion is utilized to expose the surface of a complex-shaped article to the aerosol coating. This rotary substrate motion may be effected by conventional means.

The process of the present invention provides for coating the substrate 30 at a deposition rate of from about 0.01 to about 10 microns per minute and, preferably, from about 0.1 to about 1.0 microns per minute. The thickness of the film coated upon the substrate 30 may be determined by means well known to those skilled in the art.

In a preferred embodiment of the present invention, the as-deposited coating layer consists of non-uniform grains. The term “as-deposited” refers to the film prior to the time it is subjected to the additional heat treatment described herein. In other words, this heat treatment is in addition to maintaining the substrate 30 at the temperature of at least about 100° C. intended to drive off or evaporate the solvent from the reagent solution, as previously described.

The present aerosol spray deposition process provides a substantial amount of flexibility in varying the porosity and morphology of the deposited film. By varying such parameters as the concentration of the reagent solution (a higher concentration of the metal constituents produces a larger particle size as well as a higher deposition rate), energy supplied by the ultrasonic generator (the greater the energy, the faster the deposition rate), and ultrasonic frequency (higher the frequency, smaller the particle size resulting in high surface area aerosol deposited film), the porosity and morphology of the deposited film coated onto the substrate 30 are controlled. The temperature of the substrate affects the crystal structure and coating adhesion strength.

It is preferred that the generation of the aerosol/mist 20 and its deposition onto the substrate 30 is conducted under substantially atmospheric pressure conditions. As used in this specification, the term “substantially atmospheric” refers to a pressure of at least about 600 millimeters of mercury and, preferably, from about 600 to about 1,000 millimeters of mercury. It is preferred that the aerosol generation occurs at about atmospheric pressure. As is well known to those skilled in the art, atmospheric pressure at sea level is 760 millimeters of mercury.

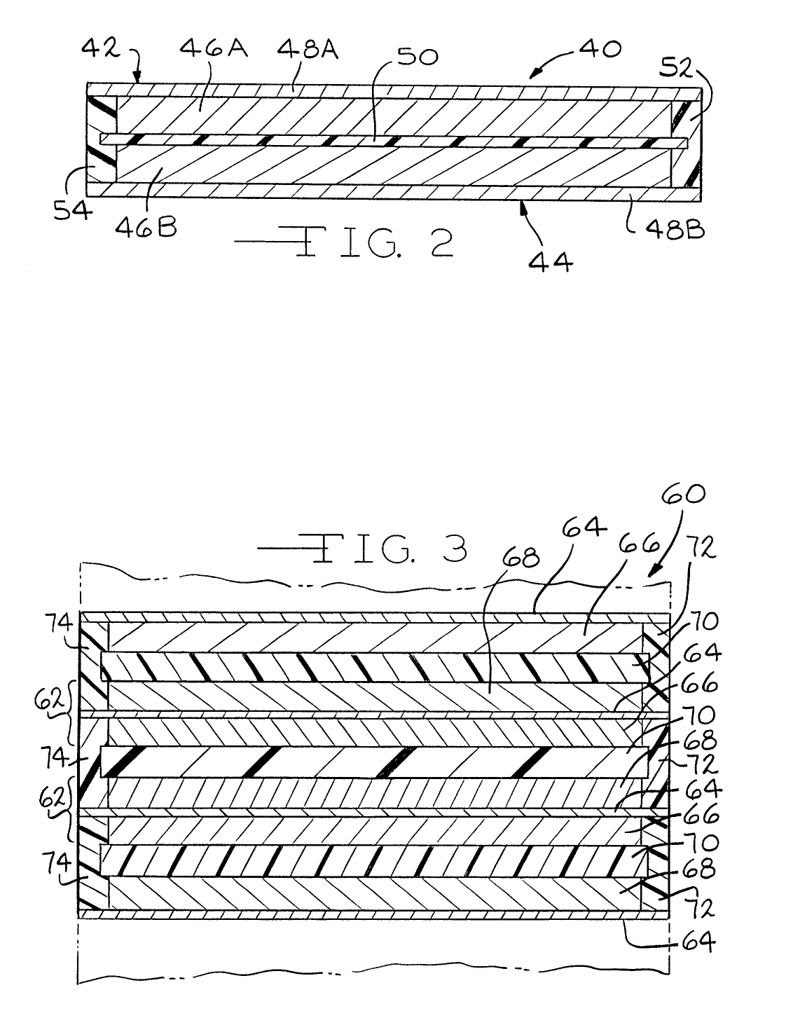

An ultrasonically coated substrate according to the present invention is useful as an electrode in various types of electrochemical capacitors including unipolar and bipolar designs, and capacitors having a spirally wound configuration. For example, in FIG. 2 there is shown a schematic representation of a typical unipolar electrochemical capacitor 40 having spaced apart electrodes 42 and 44. One of the electrodes, for example, electrode 42, serves as the cathode electrode and comprises an ultrasonically generated aerosol coating 46A of a ruthenium-containing oxide material provided on a conductive plate 48A according to the present invention. For example, a porous ruthenium oxide film is provided on plate 48A which is of a conductive material such as tantalum. The relative thicknesses of the plate 48A and the coating 46A thereon are distorted for illustrative purposes. As previously described, the plate is about 0.01 millimeters to about 1 millimeter in thickness and the ruthenium-containing oxide coating 46A is in the range of-about a few hundred Angstroms to about 0.1 millimeters thick. The other electrode 44 serves as the anode and is of a similar ruthenium-containing oxide material 46B contacted to a conductive substrate 48B, as in electrode 42.

The cathode electrode 42 and the anode electrode 44 are separated from each other by an ion permeable membrane 50 serving as a separator. The electrodes 42 and 44 are maintained in the spaced apart relationship shown by opposed insulating members 52 and 54 such as of an elastomeric material contacting end portions of the plates 48A, 48B. The end plate portions typically are not coated. An electrolyte (not shown), which may be any of the conventional electrolytes used in electrolytic capacitors, such as a solution of sulfuric acid, potassium hydroxide, or an ammonium salt is provided between and in contact with the cathode and anode electrodes 42 and 44. Leads (not shown) are easily attached to the electrodes 42 and 44 before, during, or after assembly of the capacitor and the thusly constructed unipolar capacitor configuration is housed in a suitable casing, or the conductive plates along with the insulating members can serve as the capacitor housing.

FIG. 3 is a schematic representation of a typical bipolar electrochemical capacitor 60 comprising a plurality of capacitor units 62 arranged and interconnected serially. Each unit 62 includes bipolar conductive substrate 64. Porous ruthenium-containing oxide coatings 66 and 68 are provided on the opposite sides of substrate 64 according to the present ultrasonic coating process. For example, a porous coating of ruthenium oxide film is deposited from an ultrasonically generated aerosol onto both sides of substrate 64. Again, the thickness of the porous coatings 66 and 68 is distorted for illustrative purposes. The units 62 are then assembled into the bipolar capacitor configuration on opposite sides of an intermediate separator 70. Elastomeric insulating members 72 and 74 are provided to maintain the units 62 in their spaced apart relationship. Materials other than elastomeric materials may be apparent to those skilled in the art for use as insulators 72, 74. As shown in the dashed lines, a plurality of individual electrochemical capacitor units 62 are interconnected in series to provide the bipolar configuration. The serial arrangement of units 62 is completed at the terminal ends thereof by end plates (not shown), as is well known to those skilled in the art. As is the situation with the unipolar capacitor configuration previously described, an electrolyte (not shown) is provided between and in contact with the coatings 66, 68 of the capacitor 60.

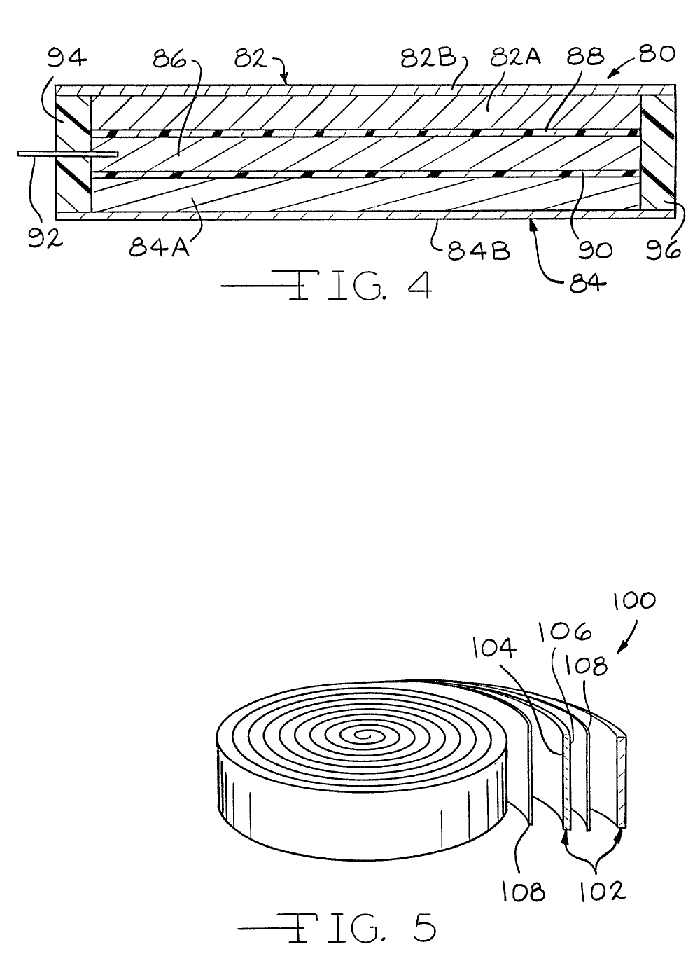

FIG. 4 shows a schematic representation of an electrolytic capacitor 80 having spaced apart cathode electrodes 82, 84, each comprising a respective ultrasonically generated aerosol coating 82A, 84A of a ruthenium-containing oxide material provided on a conductive plate 82B, 84B according to the present invention. The thickness of the porous coatings 82A, 84A is enlarged for clarity. The counter electrode or anode 86 is intermediate the cathodes 82, 84 with separators 88, 90 preventing contact between the electrodes. The anode 86 is of a conventional sintered, metal preferably in a porous form. Suitable anode metals are selected from the group consisting of titanium, aluminum, niobium, zirconium, hafnium, tungsten, molybdenum, vanadium, silicon, germanium and tantalum contacted to a terminal pin 92. The hybrid capacitor 80 is completed by insulating members 94, 96 contacting end portions of the cathode plates. While not shown, an electrolyte is provided to activate the electrodes 82, 84 and 86.

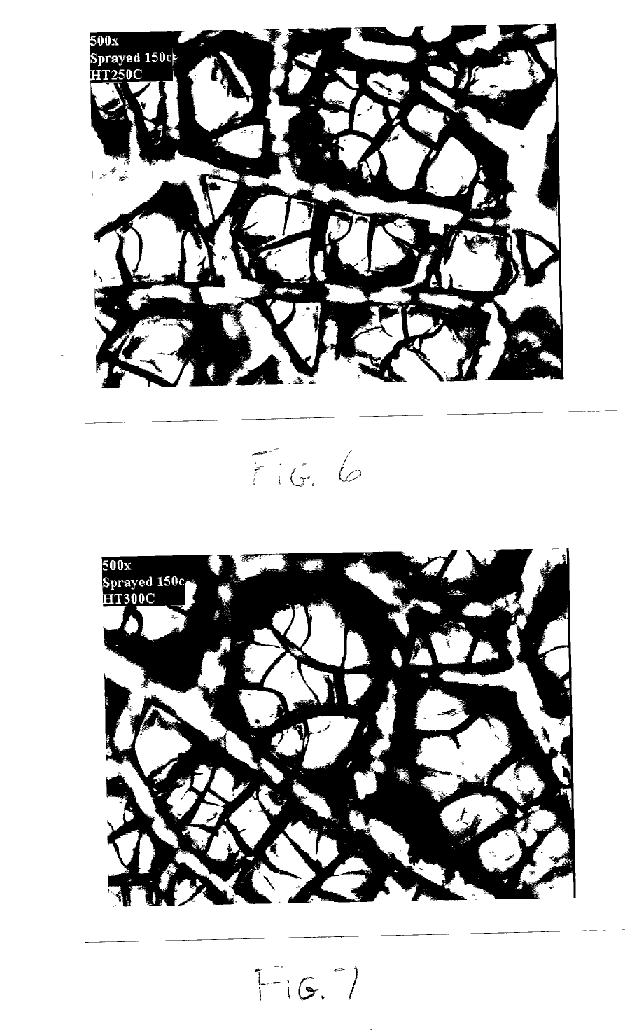

FIG. 5 is a schematic drawing of another embodiment of a jelly roll configured capacitor 100, which can be manufactured by the ultrasonic coating process according to the present invention. Capacitor 100 has a plurality of capacitor units 102, each comprising a conductive substrate provided with ultrasonically generated ruthenium-containing oxide coatings 104, 106 on the opposed sides thereof. The coatings can be, for example, of ruthenium oxide or of ruthenium tantalum oxide separated from immediately adjacent cells by an intermediate separator 108. This structure is then wound in a jelly roll fashion and housed in a suitable casing. Leads are contacted to the anode and cathode electrodes and the capacitor is activated by an electrolyte in the customary manner.

The following examples describe the manner and process of coating a substrate according to the present invention, and they set forth the best mode contemplated by the inventors of carrying out the invention, but they are not to be construed as limiting.

### EXAMPLE I

A precursor solution was prepared by dissolving 2.72 grams of ruthenium nitrosyl nitrate in a solvent that consisted of 100 cc of deionized water. If needed, a minor amount, i.e. about 5 cc of nitric acid is used to completely solubilize the precursor. The solution was stirred until the ruthenium nitrosyl nitrate was completely dissolved. A Becton-Dickinson, 10 cc. syringe was filled with the precursor solution and installed in the syringe pump. The pump was set to an injection flow rate of 0.73 cc/minute. The ruthenium precursor solution was then ready to be sprayed using the ultrasonic aerosol generator (Sonotek).

The substrate was cleaned with appropriate cleaning solutions and mounted on the temperature controlled substrate holder. The substrate was a tantalum foil, 0.002″ thick. The foil was heated to a temperature of 193° C. The ultrasonic nozzle was positioned above the substrate at a height of 7 cm. The power to the nozzle was set to 1.2 W. The shroud gas, dry and filtered air, was turned on and set to a flow rate of 10 scfh at 10 psi. This shroud gas behaves as the carrier gas and also acts as an aerosol mist shaping gas. After the foil temperature stabilized, the syringe pump was turned on. As the liquid precursor was pumped through the nozzle it was atomized into tiny droplets. The droplets were deposited on the heated substrate where the solvent evaporated and a ruthenium nitrosyl nitrate film was created on the surface of the foil. This foil was then removed and made to undergo heat treatment in a furnace. The temperature profile was as follows. The temperature was first slowly ramped up to 400° C. at 6° C./min. The temperature was maintained at this value for three hours and then cooled down naturally to the ambient temperature. The foil when removed from the furnace now had the appropriate ruthenium oxide coating.

### EXAMPLE II

A precursor solution prepared from 5.4 grams of ruthenium nitrate dissolved in a solvent consisting of 99.5 cc of deionized water and 0.5 cc of nitric acid was stirred until the ruthenium nitrate completely dissolved. The solution was deposited on a 0.002″ thick tantalum foil heated to about 150° C. The deposition process was similar to that used in Example I except that the power to the nozzle was set to 2.7 W, the flow rate for pumping the precursor solution was 5 ml./min., the shroud gas of dry and filtered air was set at a flow rate of 10 scfh at 3 psi. A vacuum of 6 inches of water was applied to the substrate to hold it against the heated support block. The nozzle height was 23 cm. at a manometer setting of 0.55 psi. Forty loops or passed back and forth with the nozzle were used to coat the substrate.

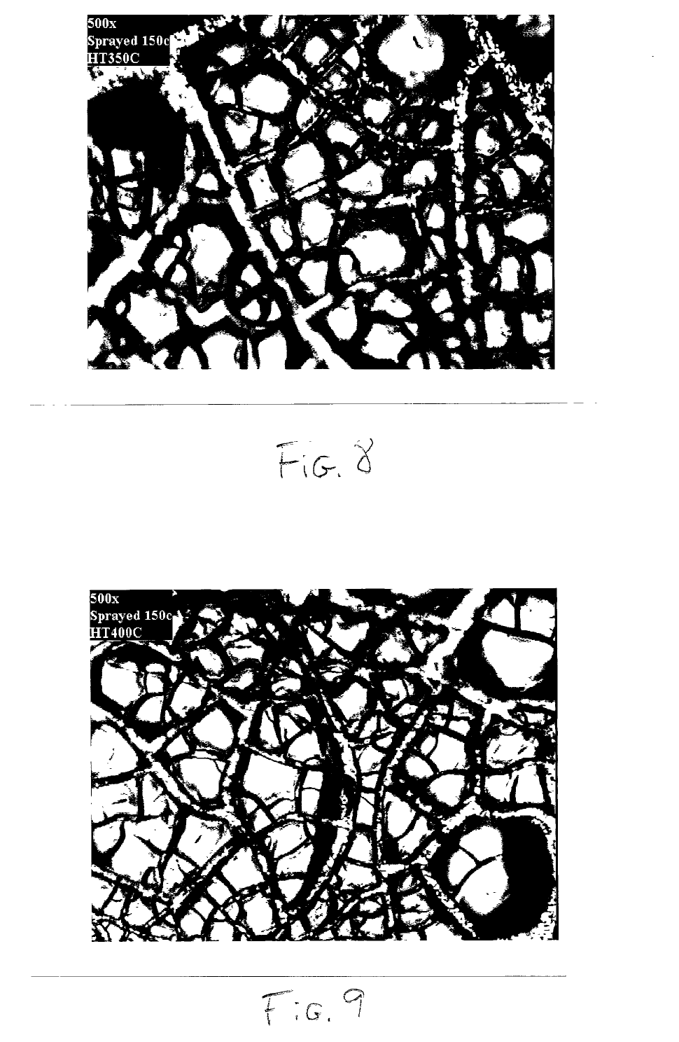

The sprayed substrates were then separated into four groups. The first group was heat-treated in a single step protocol at 250° C., the second group was heat-treated at 300° C., and the third and fourth were heat treated at 350° C. and 400° C., respectively. The substrates were then visually inspected for adhesion, flaking and overall coverage by the deposited ruthenium oxide material. The attached color photographs are the result of this visual inspection and compare the various samples at 500×. In particular, FIG. 6 to 9 are color photographs of the sample heated at 250° C., 300° C., 350° C. and 400° C., respectively.

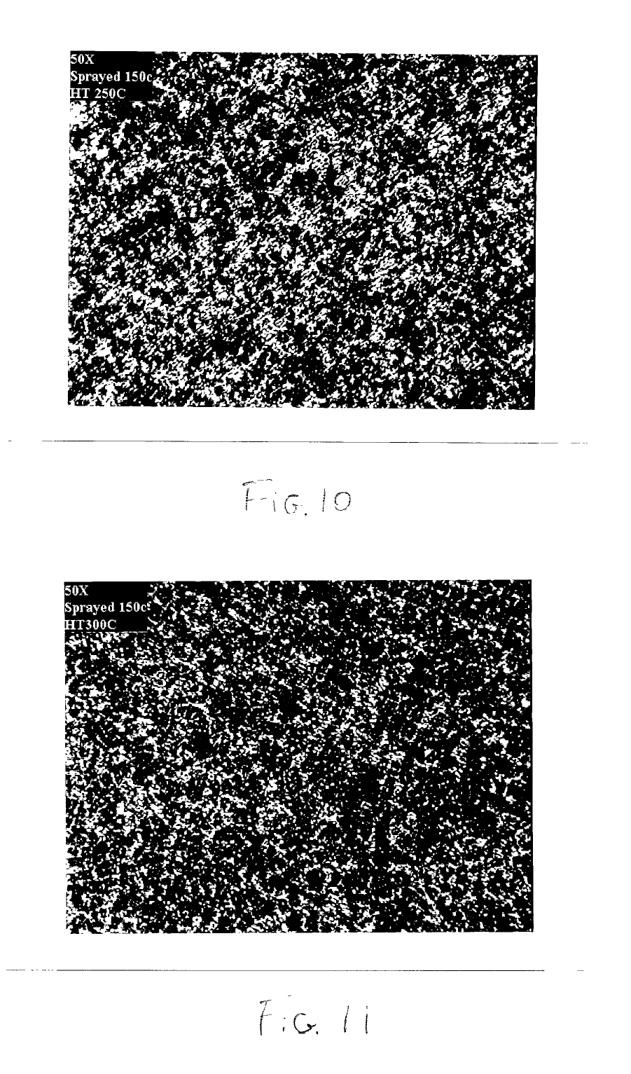

As can be seen in the color photographs, flaking of the deposited ruthenium oxide material was most severe at the lowest heat-treated temperature (250° C.) and improved as the temperature increased. In FIGS. 6 to 9, the black color is ruthenium oxide and the gold and blue colors are the titanium substrate. Adhesion to the substrate is better when the titanium is blue (FIGS. 8 and 9) in comparison to when it is gold in color. Another indicator of good adhesion is the size of the ruthenium oxide clusters. As the heat-treatment temperature increased, the particles in FIGS. 6 to 9 are closer together, thereby providing better adhesion.

### EXAMPLE III

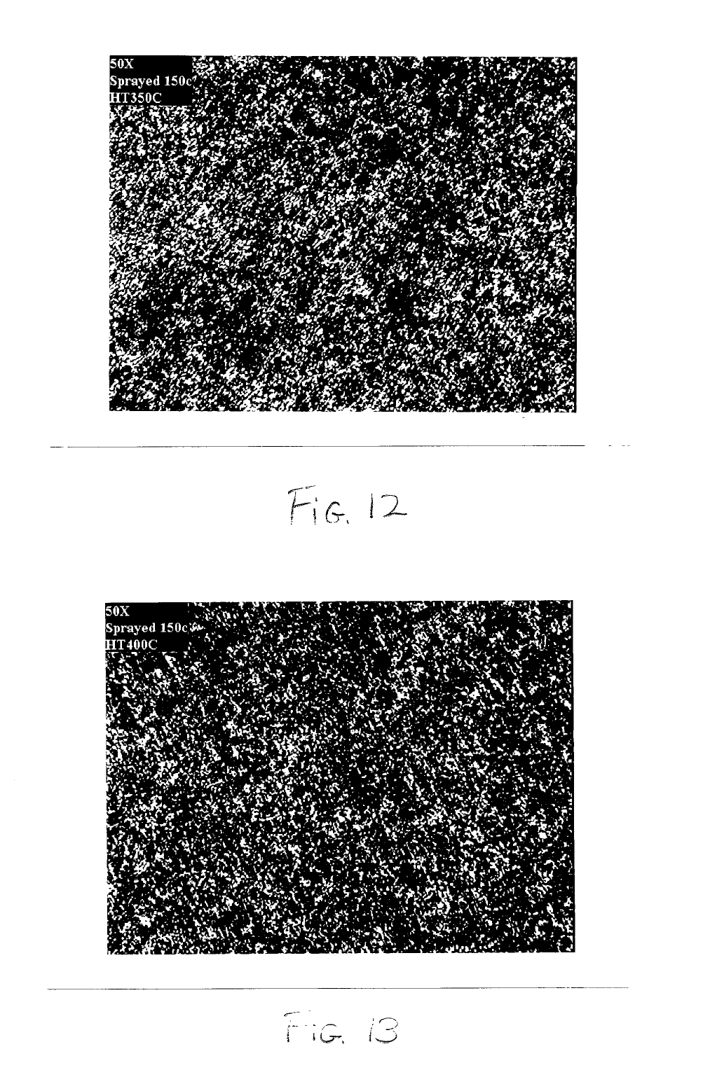

The coated substrates of Example II were then tested for adhesion by placing a small sample (½ in. disk) of them in an ultrasonic bath for three seconds and, after removal, evaluated under a microscope (50×) to compare the level of adhesion. The attached color photographs FIGS. 10 to 13 are the result of this sonication test at 250° C., 300° C., 350° C. and 400° C., respectively.

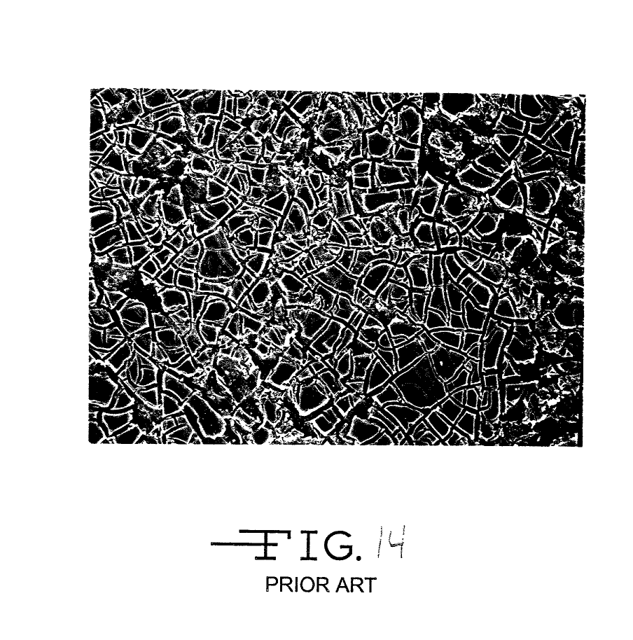

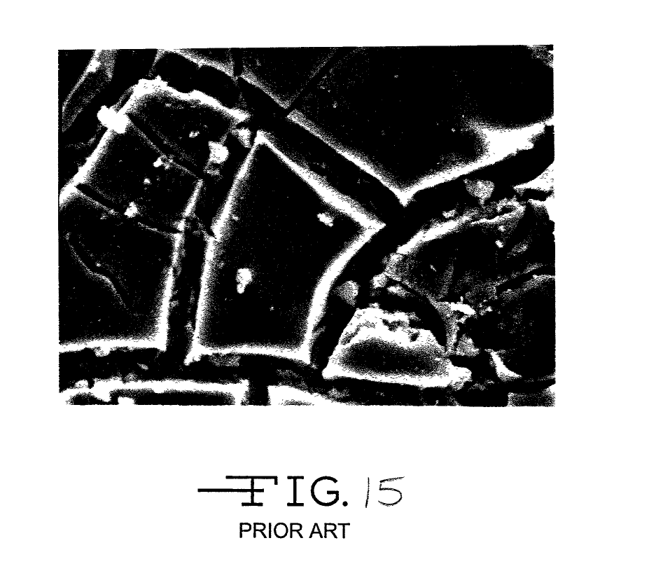

Again, there was very little adhesion occurring in the samples heat-treated at 250° C. and 300° C. (FIGS. 10 and 11). The gold color in the photographs of the samples heat-treated at those temperatures confirm that adhesion was better at 350° C. and 400° C. (FIGS. 12 and 13). Additionally, when the 350° C. and 400° C. heat-treated sample photographs are compared, the 400° C. photographs shows that there is more ruthenium oxide adhered to the titanium than in the 350° C. sample.

Therefore, based on the results of Examples I to III, it has been determined that for a ruthenium-containing compound, such as ruthenium oxide, the heating protocol must include a final heating temperature of at least 350° C. At this temperature, the ruthenium-containing compound exhibits adequate bonding to the substrate for use as an electrode in an electrochemical energy storage device.

### CONCLUSION

When a liquid is ultrasonically atomized, the droplet size in the aerosol/mist is smaller than that produced by the various prior art techniques previously discussed. This results in greater control over the manufacturing process in terms of uniformity of the coating morphology from one production run to the next. Also, there is less overspraying with the present process in comparison to pressurized air atomization spraying and the like. Furthermore, the use of an ultrasonically generated aerosol deposited on a conductive substrate to form an electrode for a capacitor according to the present invention provides a higher surface area coating than that obtainable by the prior art, and thus a higher capacitance electrode.

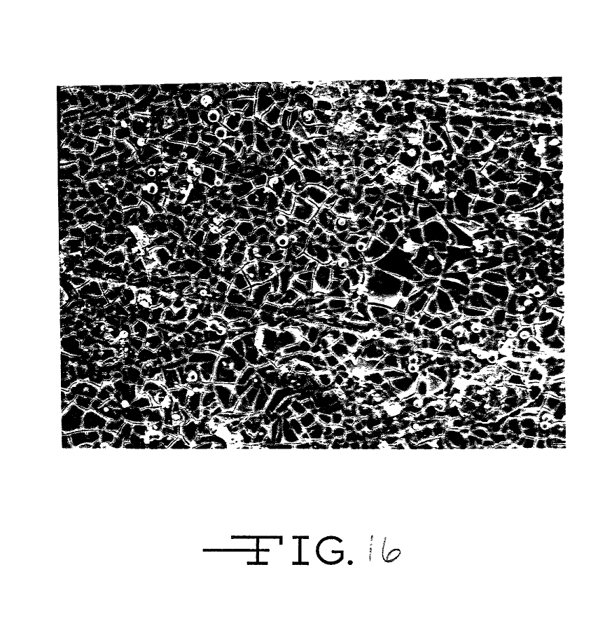

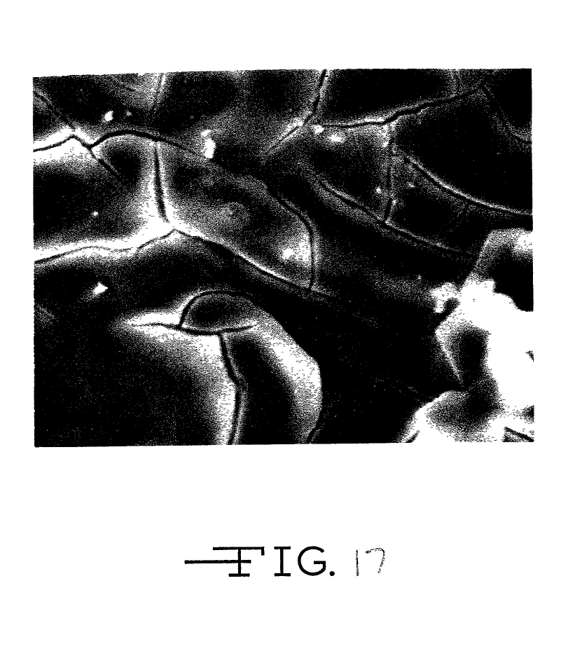

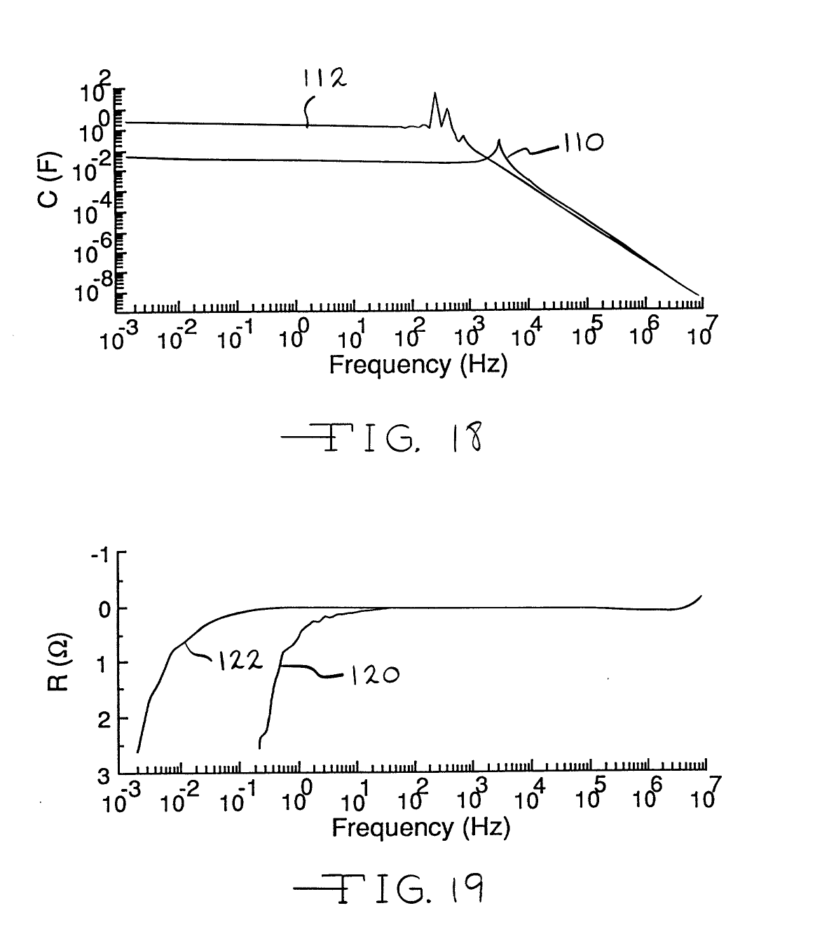

FIGS. 14 and 15 are photographs taken through an electron microscope at 500× and 5,000×, respectively, showing the surface condition of a ruthenium oxide coating produced by dipping according to the prior art. FIGS. 16 and 17 are photographs taken through an electron microscope at 500× and 5,000×, respectively, showing the surface condition of a ruthenium oxide coating produced from an ultrasonically generated aerosol/mist according to the present invention.

As is apparent, the film morphology of the present coatings is different than that of the prior art coating. The prior art coatings have a “cracked mud” appearance while the present coatings have the same “cracked mud” appearance plus additional structures on the “cracked mud” area. The cracks of the present coatings are also higher in density and thus they have an increased surface area.

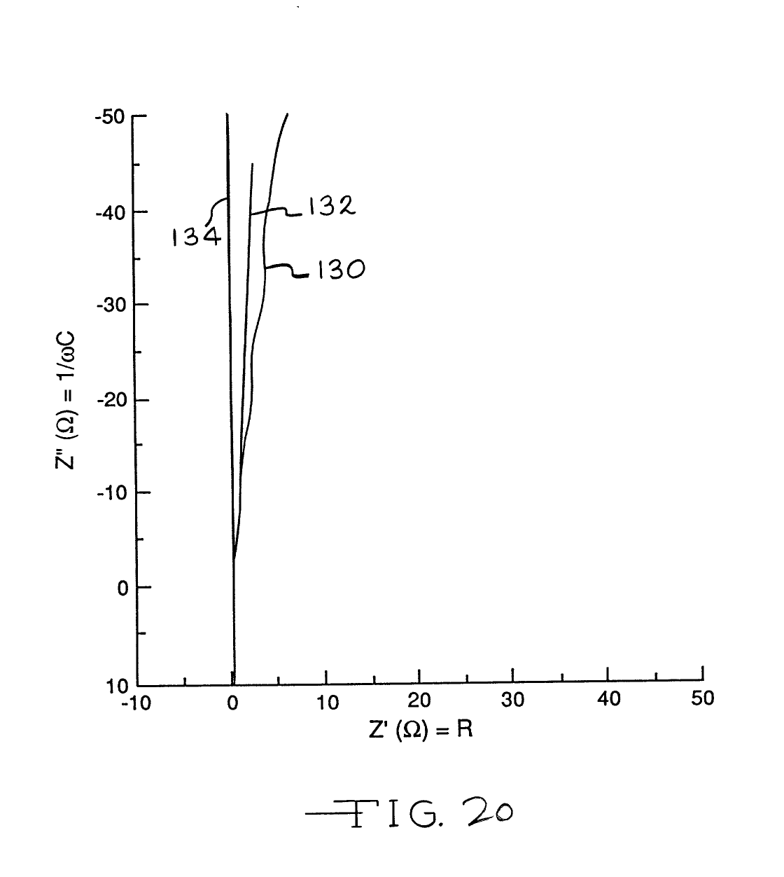

FIG. 18 is a graph of the capacitance versus frequency of various capacitors wherein curve 110 was constructed from a capacitor made according to the prior art in comparison to curve 112 constructed from a capacitor according to the present invention. FIG. 19 is a graph of the resistance versus frequency of various capacitors wherein curve 120 was constructed from a capacitor made according to the prior art in comparison to curve 122 constructed from a capacitor made according to the present invention. Further, FIG. 20 is a graph of a capacitor according to the prior art 130 in comparison to a capacitor according to the present invention 132, both plotted with respect to an ideal capacitor 134.

It has been determined that the capacitance obtained from a capacitor having an electrode made according to the present invention is on the order of 2 F/sq.in. as measured by AC impedance spectroscopy. This is in contrast to the capacitance of a capacitor having an electrode made according to the prior art which is lower.

It is appreciated that various modifications to the inventive concepts described herein may be apparent to those skilled in the art without departing from the spirit and the scope of the present invention defined by the hereinafter appended claims.

What is claimed is:

1. A coated substrate, which comprises:
a) a substrate of a conductive metal; and
b) a coating of at least a ruthenium-containing compound provided on a surface of the substrate, wherein the coating is characterized as comprising particles having been formed from an ultrasonically generated aerosol of the ruthenium-containing compound dissolved in a solvent substantially devoid of alcohol contacted with the substrate.

2. The coated substrate of claim 1 wherein the ruthenium-containing compound is a ruthenium-containing oxide, or a precursor thereof.

3. The coated substrate of claim 2 wherein the precursor of the ruthenium-containing oxide is selected from the group consisting of a nitrate, a sulfate, a phosphate and a chloride.

4. The coated substrate of claim 2 wherein the precursor is either ruthenium nitrosyl nitrate or ruthenium chloride.

5. The coated substrate of claim 1 wherein a majority of the particles have diameters of less than about 10 microns.

6. The coated substrate of claim 1 wherein an internal surface area of the coating is about 10 m²/gram to about 1,500 m²/gram.

7. The coated substrate of claim 1 wherein the coating includes a second metal.

8. The coated substrate of claim 7 wherein the second metal is selected from the group consisting of tantalum, titanium, nickel, iridium, platinum, palladium, gold, silver, cobalt, molybdenum, niobium, ruthenium, manganese, tungsten, iron, zirconium, hafnium, rhodium, vanadium, osmium, and mixtures thereof.

9. The coated substrate of claim 1 wherein the coating is comprised of ruthenium and tantalum.

10. The coated substrate of claim 1 wherein the coating has a thickness of about a hundred Angstroms to about 0.1 millimeters.

11. The coated substrate of claim 1 wherein the substrate is selected from the group consisting of tantalum, titanium, nickel, molybdenum, niobium, cobalt, stainless steel, tungsten, platinum, palladium, gold, silver, copper, chromium, vanadium, aluminum, zirconium, hafnium, zinc, iron, and mixtures thereof.

12. The coated substrate of claim 1 wherein the substrate has a thickness of about 0.001 to 2 millimeters.

13. The coated substrate of claim 1 wherein the substrate is characterized as having had its surface area increased prior to being coated.

14. The coated substrate of claim 13 wherein the increased surface area is characterized as having been formed by contacting the substrate with an acid.

15. The coated substrate of claim 13 wherein the increased surface area is characterized as having been formed by mechanical means including rough threading, grit blasting, scraping, plasma etching, abrading and wire brushing the substrate.

16. The coated substrate of claim 1 wherein the substrate is characterized as having been cleaned by one of the group consisting of an aqueous degreasing solution, a non-aqueous degreasing solution and plasma cleaning prior to being coated.

17. The coated substrate of claim 1 wherein the substrate is characterized as having had its surface increased in electrical conductivity.

18. The coated substrate of claim 1 wherein the aerosol is characterized as having been formed by subjecting the solution to ultrasonic sound waves at a frequency of about 20,000 hertz and above.

19. The coated substrate of claim 1 wherein the aerosol is characterized as having been formed by subjecting the solution to ultrasonic sound waves at a substantially atmospheric pressure of at least about 600 millimeters of mercury.

20. A method for providing a coated substrate, comprising the steps of:
a) providing the substrate having a surface to be coated;
b) providing a solution comprised of a solvent substantially devoid of alcohol and having a ruthenium-containing compound dissolved therein;
c) heating the substrate;
d) subjecting the solution to ultrasonic sound waves thereby causing the solution to form into an aerosol;
e) contacting the heated substrate with the aerosol thereby forming a coating of ultrasonically generated particles of the ruthenium-containing compound on the substrate, wherein the substrate is heated to a first temperature of at least about 100° C. and sufficient to at least partially evaporate the solvent from the substrate; and
f) further heating the ultrasonically coated substrate to a second temperature of at least about 300° C. to cause the ruthenium-containing compound to completely form and adhere to the substrate.

21. The method of claim 20 wherein the ruthenium-containing compound is a ruthenium-containing oxide or a precursor thereof.

22. The method of claim 21 wherein the precursor of the ruthenium-containing oxide is selected from the group consisting of a nitrate, a sulfate, a phosphate and a chloride.

23. The method of claim 21 including providing the precursor as either ruthenium nitrosyl nitrate or ruthenium chloride.

24. The method of claim 20 including providing a majority of the particles having diameters of less than about 10 microns.

25. The method of claim 20 including providing an internal surface area of the coating of about 10 m²/gram to about 1,500 m²/gram.

26. The method of claim 20 including providing the coating having a thickness of about a hundred Angstroms to about 0.1 millimeters.

27. The method of claim 20 including providing a second metal in the solution.

28. The method of claim 27 including selecting the second metal from the group consisting of tantalum, titanium, nickel, iridium, platinum, palladium, gold, silver, cobalt, molybdenum, ruthenium, manganese, tungsten, iron, zirconium, hafnium, rhodium, vanadium, osmium, niobium, and mixtures thereof.

29. The method of claim 20 including providing a second metal in the solution and wherein the solution includes a mixture of ruthenium and tantalum.

30. The method of claim 20 including selecting the substrate from the group consisting of tantalum, titanium, nickel, molybdenum, niobium, cobalt, stainless steel, tungsten, platinum, palladium, gold, silver, copper, chromium, vanadium, aluminum, zirconium, hafnium, zinc, iron, and mixtures thereof.

31. The method of claim 20 including increasing the surface area of the substrate prior to contacting the aerosol.

32. The method of claim 19 including increasing the substrate surface area by contacting the substrate with an acid.

33. The method of claim 31 including increasing the substrate surface area by a mechanical process selected from the group consisting of rough threading, grit blasting, scraping, plasma etching, abrading and wire brushing.

34. The method of claim 20 including cleaning the substrate by one of the group selected from an aqueous degreasing solution, a non-aqueous degreasing solution and a plasma cleaning process prior to being coated.

35. The method of claim 20 including increasing the electrical surface conductivity of the substrate prior to contacting the substrate with the aerosol.

36. The method of claim 20 including providing the substrate having a thickness of about 0.001 to about 2 millimeters.

37. A method for providing a coated substrate, comprising the steps of:
a) providing the substrate having a surface to be coated;
b) providing a solution comprised of a solvent substantially devoid of alcohol and having a ruthenium-containing oxide compound or a precursor thereof dissolved therein;
c) heating the substrate to a first temperature of at least about 100° C.;
d) subjecting the solution to ultrasonic sound waves, thereby causing the solution to form into an aerosol;
e) contacting the heated substrate with the aerosol, thereby at least partially evaporating the solvent from the substrate and forming a coating of ultrasonically generated particles of the ruthenium-containing oxide or precursor thereof on the substrate; and
f) further heating the ultrasonically coated substrate to a second temperature of at least about 300° C. to cause the ruthenium-containing oxide compound to completely form and adhere to the substrate or to convert the precursor thereof to the ruthenium-containing oxide compound adhered to the substrate.

38. A method for providing a coated substrate, comprising the steps of:
a) providing the substrate having a surface to be coated;
b) providing a solution comprised of a solvent substantially devoid of alcohol and having a ruthenium-containing oxide compound or a precursor thereof dissolved therein;
c) heating the substrate to a first temperature of at least about 100° C.;
d) subjecting the solution to ultrasonic sound waves, thereby causing the solution to form into an aerosol;
e) contacting the heated substrate with the aerosol, thereby at least partially evaporating the solvent from the substrate and beginning forming a coating of ultrasonically generated particles on the substrate; and
f) further heating the ultrasonically coated substrate to at least a second temperature of at least about 300° C. at a rate of about 1° C./minute to about 6° C./minute to cause the ruthenium-containing oxide compound to completely form and adhere to the substrate or to convert the precursor thereof to the ruthenium-containing oxide compound adhered to the substrate.
